(19) United States
(12) Patent Application Publication
(10) Pub. No.: US 2018/0356967 A1
(43) Pub. Date: Dec. 13, 2018

(54) FACILITATING AUTOMATIC GENERATION OF CUSTOMIZABLE STORYBOARDS

(71) Applicant: ADOBE SYSTEMS INCORPORATED, San Jose, CA (US)

(72) Inventor: Fabin Rasheed, Bangalore (IN)

(21) Appl. No.: 15/620,460

(22) Filed: Jun. 12, 2017

(51) Int. Cl. G06F 3/0484; G06F 17/27; G06F 17/30

(52) U.S. Cl. CPC G06F 3/04847; G06F 17/30268; G06F 3/04845; G06F 17/274

(57) ABSTRACT

Embodiments of the present invention provide systems, methods, and computer storage media for facilitating automatic generation of customizable storyboards. In embodiments, a textual scene description is received. Upon receipt of an indication to generate a storyboard, a textual analysis is performed to summarize the textual scene description and identify storyboard elements comprising characters, actions and objects. One or more images corresponding to the identified storyboard elements may be obtained, for example, from stock image libraries, custom inputs and/or custom libraries. The obtained images are combined, arranged and presented as an editable storyboard.

### BACKGROUND

In filmmaking, a scriptwriter can create a script using software products. One exemplary script development tool is Adobe® Story provided by Adobe Systems Inc. Typically, before filming occurs, the script is used to create a storyboard. A storyboard generally refers to one or more drawings (e.g., including directions and/or dialogue) that represent corresponding shots or views planned for a scene in a film (e.g., movie, television production, etc.). Accordingly, a storyboard can be used to facilitate filming. After filming has taken place, the script can be exported for use with video editing software, such as Adobe® Premiere® Pro provided by Adobe Systems Inc.

Storyboard creation can be accomplished utilizing sketching software. With conventional sketching software, a user generally manually sketches a storyboard for various script scenes. Manual storyboard creation, however, can be very time consuming. For instance, a user may review a script scene, determine which aspects of the scene to depict, sketch those aspects, and make any necessary modifications. Such a tedious process may be repeated for each script scene, resulting in extensive manual effort for generating storyboards.

### SUMMARY

Embodiments of the present invention are directed to facilitating automatic generation of customizable storyboards. In this regard, a user may input a textual scene description. A textual analysis can summarize the textual scene description and identify storyboard elements comprising characters, actions and objects. Corresponding images can be obtained from image libraries or custom image inputs. Such images can then be combined and presented as editable objects in a storyboard. As such, a user can efficiently and effectively create storyboards commensurate with the user's expectations or desires.

### BRIEF DESCRIPTION OF THE DRAWINGS

The present invention is described in detail below with reference to the attached drawing figures, wherein:

FIG. 1 is a block diagram of an exemplary computing system for generating a storyboard from a textual scene description, in accordance with embodiments of the present invention;

FIGS. 2A-2C illustrate an exemplary user interface for generating a storyboard, in accordance with embodiments of the present invention;

FIG. 3 is a flow diagram showing a method for generating storyboards according to various embodiments of the present invention;

FIG. 4 is a flow diagram showing a method for identifying storyboard elements from a scene description according to various embodiments of the present invention; and

FIG. 5 is a block diagram of an exemplary computing environment in which embodiments of the invention may be employed;

FIG. 6 is a block diagram of an exemplary computing environment suitable for use in implementing embodiments of the present invention.

### DETAILED DESCRIPTION

### Overview

Oftentimes, a user (e.g., a filmmaker or artist) might desire to generate storyboards for scenes within a script. Generally, with conventional storyboard creation software tools, a user manually generates each storyboard. By way of example only, a user may review a script scene, determine which aspects of the scene to depict, sketch those aspects, and make any necessary modifications. This process may be repeated for each script scene. As described, such storyboard creation can be tedious and time consuming.

Further, in some cases, a user might desire to customize storyboards that have been manually generated. In conventional systems, a user can manually sketch a storyboard aspect, but to reuse the aspect, the user must manually import it. For example, the user could navigate to a previous sketch, copy a desired image to the clipboard, navigate to a later sketch, and paste the image into the later sketch. Again, such a process is tedious and time consuming, resulting in an unsatisfactory process.

Accordingly, embodiments of the present invention are directed to facilitating automatic generation of customizable storyboards. In particular, a user may input one or more script scenes, for example, as a file containing a textual scene description, such as a script generated via Adobe® Story. Such a textual scene description can be summarized and analyzed to identify storyboard elements, such as characters, actions, and objects in text form, to include in a storyboard. Images corresponding with the identified storyboard elements can be obtained from image libraries, such as vector repositories, and presented in the form of a storyboard, for example as graphical elements depicted in a graphical viewing region. The images representing the storyboard elements in the viewing region can be manipulated in any number of ways, for example, by moving, scaling and rotating.

In some embodiments, a user can input custom images for use in one or more storyboards. For example, instead of presenting an image of an identified storyboard element from a library of stock images, a custom image can be detected from a custom input and presented in the storyboard. The custom image can be stored in a custom library such that other storyboards with the same storyboard element can use the same custom image.

As such, using implementations described herein, a user can efficiently and effectively create storyboards commensurate with the user's expectations or desires. Further, a user can efficiently customize storyboards, for example, via tools that enable a user to edit automatically generated storyboards, create custom images for use in automatically generated storyboards, or the like.

Having briefly described an overview of aspects of the present invention, various terms used throughout this description are provided. Although more details regarding various terms are provided throughout this description, general descriptions of some terms are included below to provider a clearer understanding of the ideas disclosed herein:

A script generally refers to a written work for a film, play, video game or any broadcast, and can describe characters, dialogues, and actions. A script scene generally refers to a script associated with a particular scene. A script element or scene element as used herein generally refers to various aspects of a script scene, such as but not limited to, a scene heading, an action, a character name, a dialogue, a parenthetical, etc.

A scene description or textual scene description generally refers to a textual description of a scene. A storyboard element, as used herein, generally refers to a representation or indication, in text form, of a character, an action and/or an object that makes up the scene depicted, or to be depicted, in a storyboard. As described herein, storyboard elements can be automatically identified from a scene description.

A storyboard generally refers to a visual depiction of a scene. A storyboard can have one or more drawings or images that represent views planned for a scene in a film.

### Exemplary Automated Storyboarding Environment

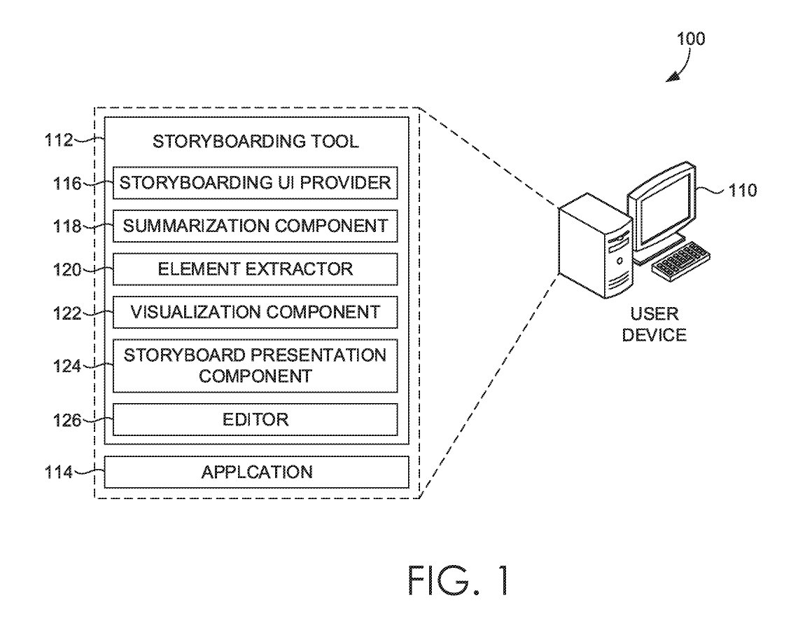

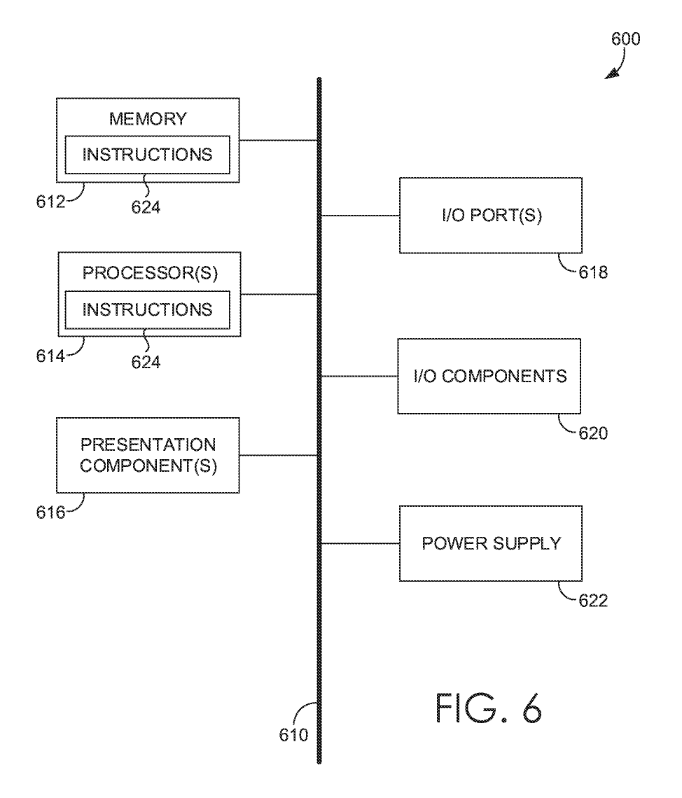

Referring now to FIG. 1, a block diagram of an exemplary environment 100 suitable for use in implementing embodiments of the invention is shown. Generally, the environment 100 is suitable for screenwriting and/or storyboard creation, and, among other things, facilitates automatic generation of storyboards from a textual scene description. The environment 100 includes a user device 110 having a storyboarding tool 112. As described, the storyboarding tool generates a storyboard from a textual scene description and can facilitate storyboard customization. The user device 110 can be any kind of computing device capable of facilitating screenwriting and/or storyboard creation. For example, in an embodiment, the user device 110 can be a computing device such as computing device 600, as described below with reference to FIG. 6. In embodiments, the user device 110 can be a personal computer (PC), a laptop computer, a workstation, a mobile computing device, a PDA, a cell phone, or the like.

As illustrated, the user device 110 includes storyboarding tool 112. The storyboarding tool 112 may be incorporated, or integrated, into an application or an add-on or plug-in to an application, such as application 114. Application 114 may generally be any application capable of facilitating screenwriting and/or storyboard creation. As can be appreciated, in some embodiments, in addition to facilitating screenwriting and/or storyboard creation, application 114 may also facilitate the presentation of storyboards or other aspects of filmmaking Application 114 may be a stand-alone application, a mobile application, a web application, or the like. In some implementations, the application(s) comprises a web application, which can run in a web browser, and could be hosted at least partially server-side. In addition, or instead, the application(s) can comprise a dedicated application. In some cases, the application can be integrated into the operating system (e.g., as a service). One exemplary application that may be used for screenwriting is Adobe® Story, which is a professional screenwriting application. Although generally discussed herein as storyboarding tool 112 being associated with an application, in some cases, storyboarding tool 112, or portion thereof, can be additionally or alternatively integrated into the operating system (e.g., as a service) or a server (e.g., a remote server).

Storyboarding tool 112 is generally configured to facilitate storyboard creation. In particular, storyboarding tool 112 is used to perform a textual analysis of a scene description to summarize and identify key aspects of the scene for visual representation in a storyboard. In this way, the elements of a storyboard (storyboard elements) can be identified from a scene description. Storyboard elements, as used herein, generally refer to text representing or associated with characters, actions, and/or objects that make up the scene depicted, or to be depicted, in a storyboard. As described herein, a set of storyboard elements can be automatically identified from a scene description. Thereafter, images depicting the storyboard elements can be obtained, for example, by searching an appropriate image repository such as a vector repository containing potential scene characters. In this manner, storyboarding tool 112 may be used to generate a storyboard by combining and arranging the images obtained for various storyboard elements and presenting the images in a viewing region of a user interface. This process may be repeated for each scene, with the resulting storyboards saved in a project or other application program data.

A user may desire to edit or customize the automatically generated storyboards. Accordingly, storyboarding tool 112 may be configured to facilitate storyboard editing and customization. By way of example only, the images presented in the viewing region may be moved, scaled and rotated. Additionally, a user may desire to input custom images for use in place of automatically obtained images. Accordingly, in some embodiments, storyboarding tool 112 may provide a user interface that permits a user to select a custom image to import. Additionally or alternatively, storyboarding tool 112 may provide one or more custom drawing regions. When a custom image is input, storyboarding tool 112 can utilize that image for a corresponding storyboard element instead of searching an image library, and present the custom image in the viewing region as part of the storyboard. As with the images obtained from libraries, custom images presented in the viewing region may also be modified such as by moving, scaling and rotating. Accordingly, a user can efficiently generate and customize a desired storyboard.

In embodiments, storyboard creation via storyboarding tool 112 may be initiated and/or presented via an application, such as application 114 operating on user device 110. In this regard, user device 110, via application 114, might allow a user to initiate storyboard creation. Storyboard creation might be initiated in any number of ways. In one example, a storyboarding tool might be initiated based on a user selection, for example, by selecting a displayed textual scene description, such as a script action element. Alternately and/or additionally, a storyboarding tool might be initiated based on the selection of a button, icon or other user input. In yet another example, a storyboarding tool may be initiated in accordance with opening or launching an application, such as application 114, or opening or launching an existing project that includes one or more storyboards (e.g., previously designed by a user).

As shown in FIG. 1, storyboarding tool 112 can include storyboarding user interface (UI) provider 116, summarization component 118, element identifier 120, visualization component 122, storyboard presentation component 124 and editor 126. It should be understood that this and other arrangements described herein are set forth only as examples. Other arrangements and elements (e.g., machines, interfaces, functions, orders, groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory. The functionality described herein can be performed with respect to any number of components. For example, presentation of a storyboard may be performed by storyboarding user interface provider 116 and/or editor 126. Similarly, the functions described herein with respect to one or more components such as storyboarding user interface provider 116, visualization component 122 and/or storyboard presentation component 124 could be performed by the same component. Further, although storyboarding tool 112 is illustrated in connection with user device 110, as can be appreciated, functionality described herein may be additionally or alternatively carried out remotely, for example, via a server or other component in connection with user device 110.

In operation, storyboarding user interface provider 116 can provide a storyboarding experience that enables a user to provide input in an effort to facilitate storyboard creation. In particular, storyboarding user interface provider 116 enables a user to input, select or otherwise designate a textual description of one or more scenes. For example, storyboarding user interface provider 116 may provide a text input region for a user to enter in a scene description. In another example, storyboarding user interface provider 116 may allow a user to input saved textual scene descriptions, for example, residing in a saved script file (e.g., selected from an action scene element for a scene in the script file). In yet another example, storyboarding user interface provider 116 may interact with aspects of an application, such as application 114, to receive one or more textual scene descriptions, for example, from a saved script file, from a textual description selected from a displayed script or from text recognition software, such as voice-to-text software. In this regard, storyboarding tool 112 receives a textual scene description.

A typical scene description contains a textual description or indication of characters, actions and/or objects. For example, “THELMA and LOUISE drive their car on the highway” or “DOROTHY is walking on the yellow brick road.” The challenge is to automatically identify aspects of the scene description for visualization. In embodiments, storyboarding tool 112 accomplishes this using summarization component 118 and element identifier 120 to perform a textual analysis of the scene description. As can be appreciated, summarization component 118 summarizes the scene description, for example, reducing it to one or two simple sentences. Any number of known automatic summarization techniques may be utilized and are within the scope of the present disclosure. It should be noted that if the textual scene description is already in a form suitable for the next stage of the textual analysis, summarization component 218 need not perform any transformation on the description.

Element identifier 120 generally performs an analysis on the scene description, such as a summarized scene description, to identify the constituent storyboard elements. By way of example only, element identifier 120 may perform a textual analysis using a dictionary reference and natural language processing to identify the nouns and verbs in the summarized scene description. Nouns can be further separated into proper nouns and objects, and scene characters can be identified from the proper nouns. Actions can be identified from the verbs identified from the scene description. In this manner, element identifier 120 can identify the characters, actions and objects present in a scene description.

In order to obtain a relevant character image, a tagging component or tagger (not shown) may perform an analysis (e.g., textual analysis such as natural language processing) on any identified storyboard element, such as an identified character, for example, to identify visual characteristics, such as gender and any special features that can be used to identify relevant visualizations. These visual characteristics can be used as text identification tags associated with the character. For example, if a scene description is, “JOHN is a young, bald, Caucasian man,” then John may be taken as the character and the tags “male,” “young,” “bald,” and “Caucasian” are associated with John. In a similar manner, tags can be created and associated with objects identified in a scene description. In some embodiments, an identified verb or action can also be used as a tag.

Visualization component 122 can be used to obtain visualizations, such as one or more images, that correspond to the textual indications of characters, actions and/or objects identified from a scene description. Images can be obtained in any number of ways. The examples provided herein are intended merely to illustrate exemplary embodiments of visualization component 122 and are not intended to be limiting.

In some implementations, visualization component 122 may obtain relevant images from image libraries, such as vector repositories. Accordingly, visualization component 122 may be communicatively coupled to a desired library, which may be located locally, remotely (e.g., via the cloud) or some combination thereof. As can be appreciated, each record in a library may be indexed using one or more descriptive terms. As such, visualization component 122 may search a library index for relevant images. One exemplary repository is Adobe® Stock, which contains vector graphics. Vector graphics may be advantageous due to the ease with which they may be manipulated with minimal resulting loss in image clarity. However, the present disclosure is not limited to vector graphics. In embodiments, character, action and/or object repositories may be searched to locate corresponding images. If a storyboard element is associated with one or more tags, the tags may be used in combination with the storyboard element to match an appropriate image. For example, where a character (e.g., John) has various associated tags including an action (e.g., male, young, bald, Caucasian, throws), visualization component 122 may search a character repository using these tags for a young, bald, Caucasian male in a throwing position. In some embodiments, instead of an identified verb or action being used as a tag, a corresponding template modification may be performed on an obtained image. In the example above, if visualization component 122 obtains an image of a young, bald, Caucasian male, visualization component 122 may then apply a modification to produce a throwing position.

Additionally and/or alternatively, visualization component 122 may obtain relevant images, or portions thereof, with the assistance of a visual analysis (e.g., performed on images in image libraries) that automatically classifies and tags images for visual characteristics (e.g., “person,” “male,” “female,” etc.), which can be indexed and searched to locate relevant images. For example, the visual analysis may include the use of a convolutional neural network in association with one or more deep learning algorithms to identify visual characteristics of images in image libraries. In some embodiments, visualization component 122 may extract or utilize one or more extracted portions of an image for use in storyboards, such as by using semantic segmentation and other image segmentation algorithms. By way of nonlimiting example, an image of child playing with a ball can be accessed from an image library, and the portion of the image containing the ball can be extracted and/or accessed for use in a storyboard.

Sometimes, a user may desire to use a custom image instead of a stock image from a library. Accordingly, in some embodiments, storyboarding user interface provider 116 permits a user to input one or more custom images. For example, storyboarding user interface provider 116 may permit a user to select one or more custom images to import. Additionally and/or alternatively, storyboarding user interface provider 116 may provide one or more custom drawing regions where a user may draw a custom image using user device 110. In some embodiments, storyboarding user interface provider 116 may accept an input generated from a tablet, electronic sketch pad or other device capable of receiving a user sketch. Any number of known sketching, drawing and painting software techniques may be utilized and are contemplated within the scope of the present disclosure.

When a user inputs a custom image, storyboarding user interface provider 216 may provide the custom image to visualization component 122 for use in place of a library image. In some embodiments, the number of characters and objects in a scene description can be determined and a custom image can be input for each. Various techniques can be used to associate a custom image with a particular storyboard element. By way of example, inputs entered chronologically (i.e., in order of time) or directionally (e.g., left to right) via the user interface may be associated with storyboard elements (or some subset such as objects only) in their order of appearance in a scene description (i.e., left to right). In some embodiments, storyboarding user interface provider 116 may identify and provide custom input regions such as custom drawing regions that are associated with identified storyboard elements. In yet another example, the user can select from a list of identified storyboard elements and manually associate a custom image with an identified storyboard element.

In embodiments, custom libraries can be built from custom images that have been provided by a user. For example, each time a user inputs a custom image such as a custom drawing, the custom image can be added to a user-specific custom library and associated with a corresponding storyboard element. For example, the custom library may include a searchable index of one or more descriptive terms for each custom image. The custom library may be accessible, for example, from a designated workspace or project. As with the image libraries discussed above, custom libraries may be located locally, remotely (e.g., via the cloud) or some combination thereof. In this regard, each time the same storyboard element appears in other scene descriptions in the designated workspace or project, the corresponding custom image may be obtained from the user's custom library. For example, if the user has imported custom images for various objects (e.g., ball, stone, wall, etc.), these custom images can be used to build a custom object library for that user. Accordingly, when scene descriptions in the designated workspace or project include one of those objects, visualization component 122 may obtain the custom image for that object from the user's custom object library.

As described above, visualization component 122 identifies images for the storyboard elements in a scene description. These images are generally combined, arranged and presented as a storyboard. The storyboard can be presented in any number of ways, and the examples provided herein are intended merely to illustrate exemplary embodiments of storyboard presentation and are not intended to be limiting. In some implementations, a storyboard may be presented in a storyboard viewing region on user device 110. For example, visualization component 122 may provide the obtained images to storyboard presentation component 124, which combines and arranges the images for presentation (e.g., by storyboarding user interface provider 116) in the viewing region. In embodiments where storyboarding user interface provider 116 controls system inputs and outputs which can include control of the viewing region, storyboard presentation component 124 may provide the storyboard to storyboarding user interface provider 116 for display on user device 110.

Storyboard presentation component 124 generally combines and arranges the obtained images in an intuitive manner. In some embodiments, obtained images can be combined so they appear in the viewing region in the same order the corresponding storyboard elements appear in the summarized scene description (i.e., left to right). Of course, other geometric arrangements of images in a storyboard are possible and contemplated within the present disclosure.

Users may desire to edit generated storyboards. Accordingly, storyboard presentation component 124, storyboarding user interface provider 116 and editor 126 generally operate together to facilitate storyboard editing. For example, because a user may desire to edit one or more constituent images independently of any others, the images can be maintained as separate images, although presented as a single storyboard. In this manner, each constituent image can be manipulated (e.g., scaled in size, moved in position, etc.) in response to a user input. For example, a user desiring to execute a command such as resizing image A in storyboard X might provide an input indicating the command to storyboarding user interface provider 116 (e.g., by selecting the image in the viewing region and resizing an image boundary). Storyboarding user interface provider 116 may provide this command to editor 126, which can execute the resizing command on image A and provide resized image A to storyboard presentation component 124 for arrangement and presentation in revised storyboard X. Any number of known image editing techniques may be utilized and are contemplated within the scope of the present disclosure. In this manner, customizable storyboards may be efficiently generated.

As can be appreciated, the process described above can be repeated for multiple scenes to generate multiple storyboards. Projects containing multiple storyboards can be saved and exported in various formats, including existing image formats such as .JPG, .TIFF, and .PNG, to name a few. Storyboards may also be capable of import into other software, such as video editing software.

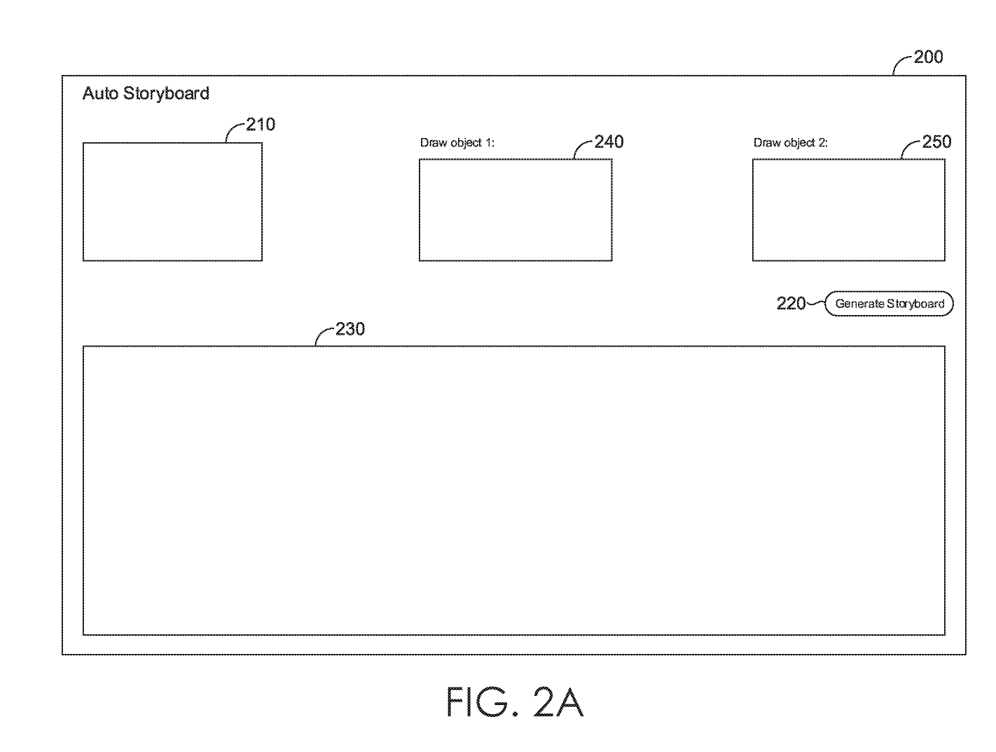

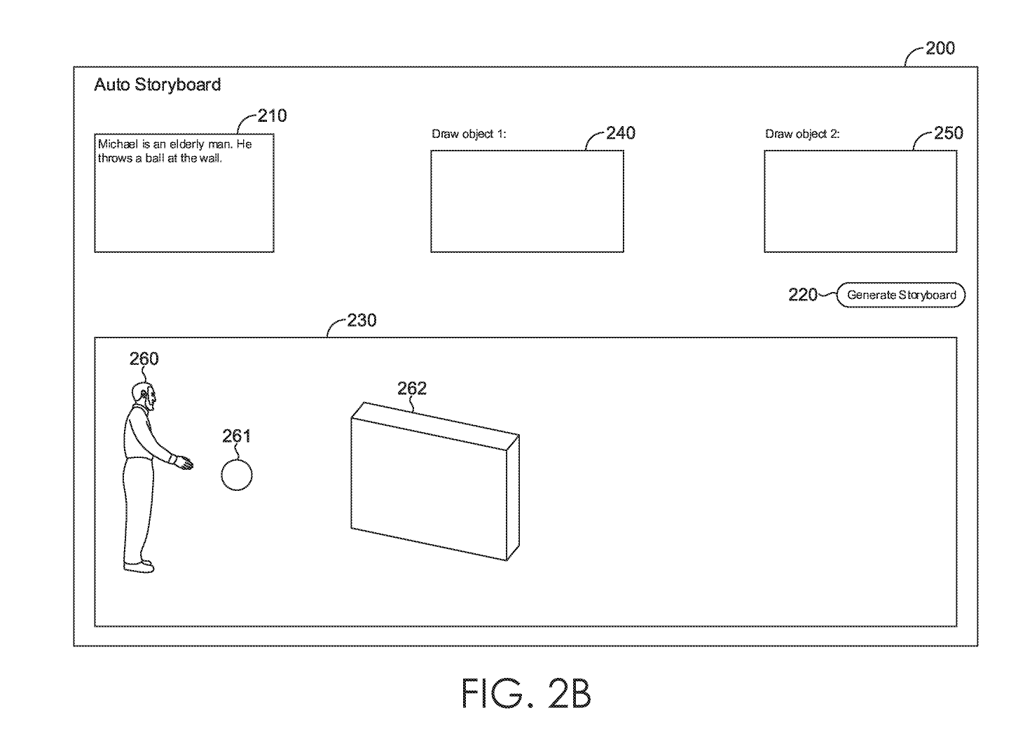

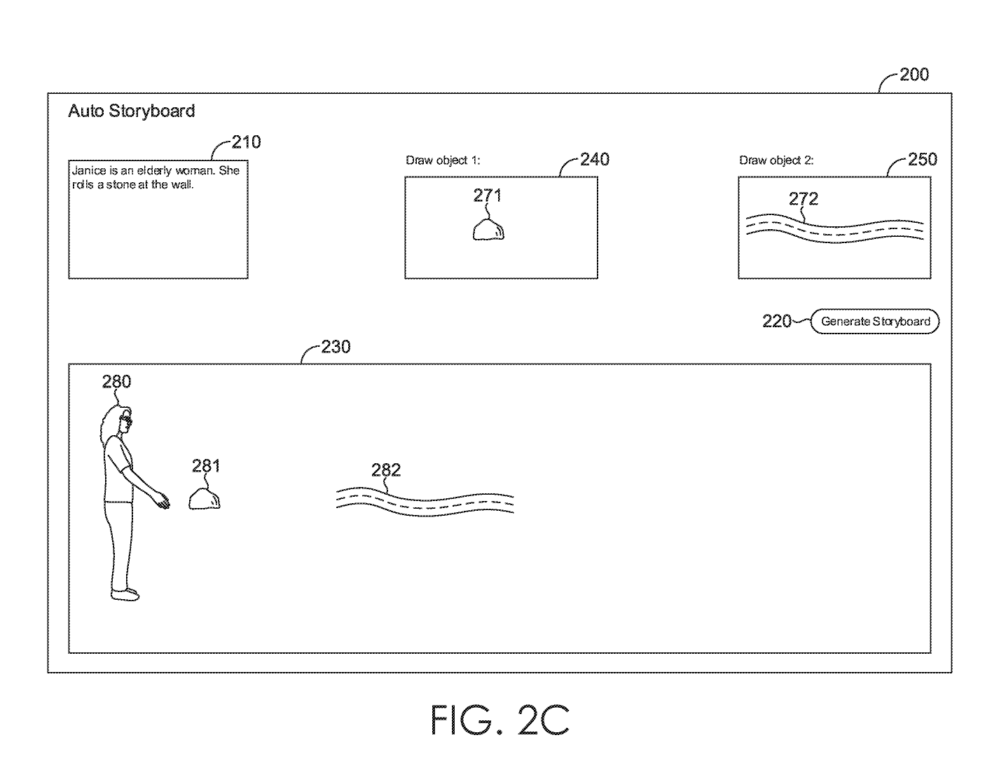

With reference to FIGS. 2A-2C, FIGS. 2A-2C illustrate an exemplary user interface representing snapshots of a storyboard being generated and presented. In each of FIGS. 2A-2C, user interface 200 includes text input region 210, storyboard generation button 220, viewing region 230 and custom drawing regions 240 and 250. Generally, a user may input a textual scene description into text input region 210 and activate storyboard generation button 220 to generate a storyboard in viewing region 230. FIG. 2A illustrates user interface 200 before a user has entered a scene description. With reference to FIG. 2B, a user has entered an exemplary textual scene description into in text input region 210 (“Michael is an elderly man. He throws a ball at the wall.”). Based upon activation of storyboard generation button 220, user interface 200 displays an automatically generated storyboard in viewing region 230. The storyboard in FIG. 2B includes images 260, 261 and 262 corresponding to the storyboard elements identified in the textual scene description appearing in text input region 210. More specifically, image 260 has been selected to depict Michael as an elderly man in a throwing position, image 261 has been selected to depict a ball, and image 262 has been selected to depict a wall.

With reference to FIG. 2C, FIG. 2C illustrates a storyboard generated from an exemplary textual scene description and custom drawings. Here, a user has entered an exemplary textual scene description into text input region 210 (“Janice is an elderly woman. She rolls a stone at the wall.”). The user has also entered custom drawing 271 (a rock) in custom drawing region 240 and custom drawing 272 (a road) in custom drawing region 250. Based upon activation of storyboard generation button 220, user interface 200 displays an automatically generated storyboard in viewing region 230. The storyboard in FIG. 2C includes images 280, 281 and 282 corresponding to the storyboard elements identified in the textual scene description, as customized by custom drawings 271 and 272. More specifically, image 280 has been selected to depict Janice as an elderly woman in a position to roll an object. Image 281 corresponds to the first object identified in the textual scene description (a stone). Based on the presence of custom drawing 271 in the first custom drawing region, this custom drawing has been used as image 281 in the storyboard. Similarly, image 282 corresponds to the second object identified in the textual scene description (the wall). Again, based on the presence of custom drawing 272 in the second custom drawing region, this custom drawing has been used as image 282 in the storyboard. As can be appreciated, the presence of custom drawings 271 and 272 can override a call to a stock image library. Accordingly, image 282 in viewing region 230 depicts a road (custom drawing 272) instead of a wall.

As can be appreciated, any number or type of relationships can be generated and used to manipulate various components associated with a motion imagery in accordance with an audio.

### Exemplary Flow Diagrams

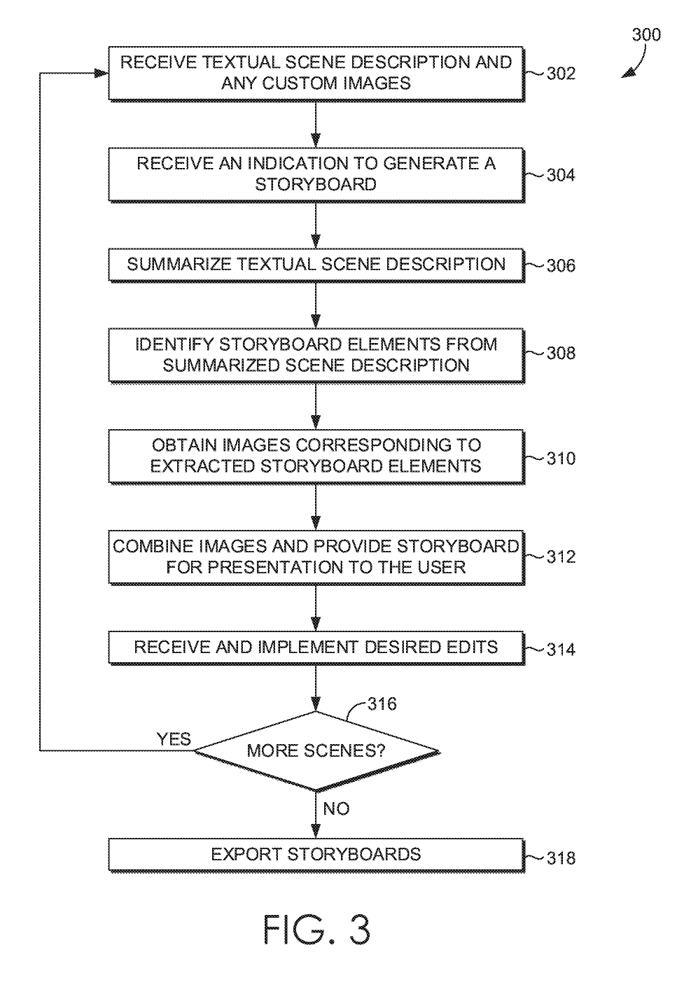

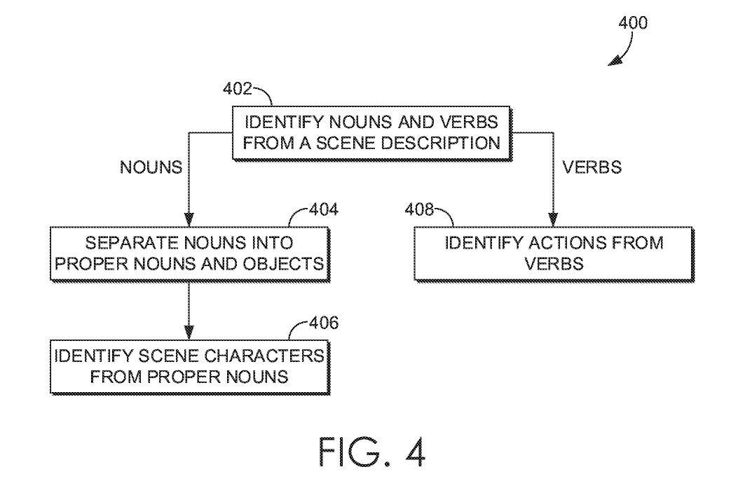

With reference now to FIGS. 3-4, flow diagrams are provided illustrating methods for generating storyboards. Each block of the methods 300 and 400 and any other methods described herein comprises a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

Turning initially to FIG. 3, FIG. 3 illustrates a method 300 for generating storyboards, in accordance with embodiments described herein. At block 302, a textual scene description and any custom images are received. A user may provide a textual scene description in any number of ways, such as, for example, by importing a script file, entering text, etc. A user may also provide any desired custom images, for example, by creating a drawing in a custom drawing region. At block 304, an indication to generate a storyboard is received. For example, a user may activate a button or icon provided by the user interface. Then, the textual scene description is summarized, as indicated at block 306. The output of the summarization block can be one or two simple sentences, for example. At block 308, storyboard elements comprising characters, verbs and objects are identified from the summarized scene description. Method 400 and FIG. 4, described below, details one possible way this may be accomplished. At block 310, one or more images are obtained corresponding to the identified storyboard elements. For example, image libraries can be searched to obtain an image corresponding to an identified character, an identified action and/or an identified object. Images may also be obtained from custom image inputs. For example, a user may import a custom image or draw one in a custom drawing region. At block 312, the obtained images are combined, arranged and provided as a storyboard for presentation to the user. For example, the user interface may display the images as a storyboard in a viewing region in the user interface. The user can edit any of the images at block 314, for example, by moving, scaling and/or rotating them. In this regard, the user can automatically generate a customizable storyboard for a scene. If there are additional scenes to be generated, decisional block 316 directs the process back to block 302. Otherwise, any storyboards may be exported at block 318, for example, as an image file.

Turning now to FIG. 4, a flow diagram is provided that illustrates a software method 400 for identifying storyboard elements from a textual scene description, in accordance with embodiments described herein. At block 402, a software textual analysis is performed to identify nouns and verbs from a scene description. The nouns can be further separated into proper nouns and storyboard element objects, as depicted at block 404. Then at block 406, scene characters can be identified from any proper nouns. At block 408, the verbs identified at block 402 are analyzed to identify any actions. In this manner, a software textual analysis can identify the characters, actions and objects from a textual scene description.

The subject matter of the present invention is described with specificity herein to meet statutory requirements. However, the description itself is not intended to limit the scope of this patent. Rather, the inventor has contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Exemplary Computing Environment

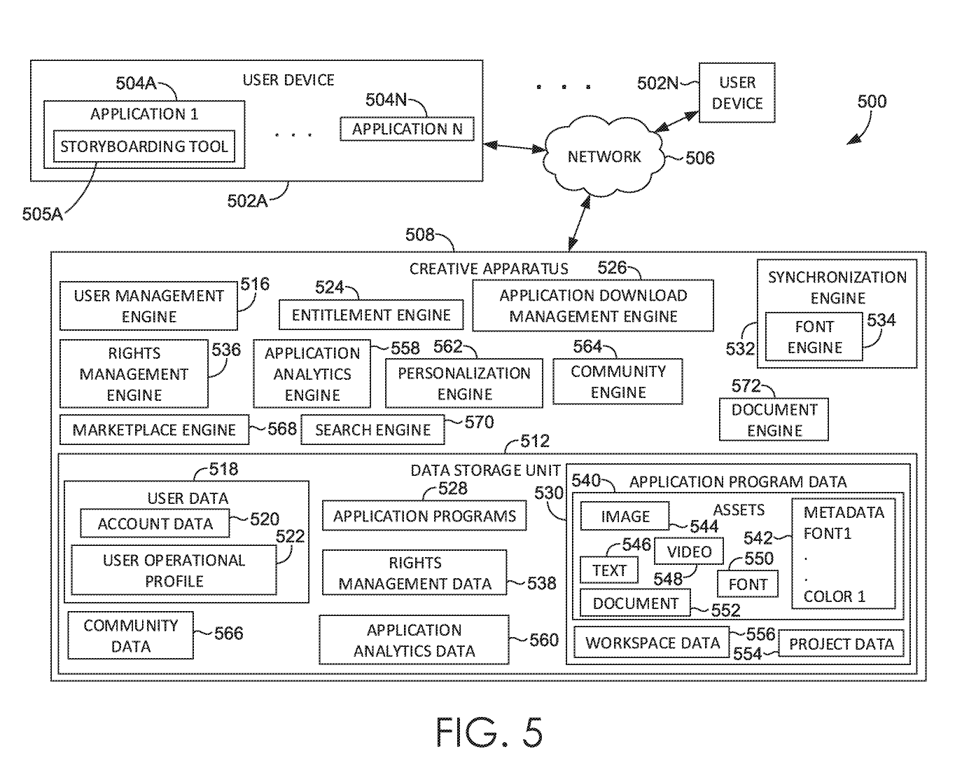

FIG. 5 is a diagram of an environment 500 in which one or more embodiments of the present disclosure can be practiced. The environment 500 includes one or more user devices, such as a user devices 502A-502N. Examples of the user devices include, but are not limited to, a personal computer (PC), tablet computer, a desktop computer, cellular telephone, a processing unit, any combination of these devices, or any other suitable device having one or more processors. Each user device includes at least one application supported by the creative apparatus 508. It is to be appreciated that following description may generally refer to the user device 502A as an example and any other user device can be used.

A user of the user device can utilize various products, applications, or services supported by the creative apparatus 508 via the network 506. The user devices 502A-502N can be operated by various users. Examples of the users include, but are not limited to, creative professionals or hobbyists who use creative tools to generate, edit, track, or manage creative content, advertisers, publishers, developers, content owners, content managers, content creators, content viewers, content consumers, designers, editors, any combination of these users, or any other user who uses digital tools to create, edit, track, or manage digital experiences.

A digital tool, as described herein, includes a tool that is used for performing a function or a workflow electronically. Examples of a digital tool include, but are not limited to, content creation tool, content editing tool, content publishing tool, content tracking tool, content managing tool, content printing tool, content consumption tool, any combination of these tools, or any other tool that can be used for creating, editing, managing, generating, tracking, consuming or performing any other function or workflow related to content. A digital tool includes the creative apparatus 508.

Digital experience, as described herein, includes experience that can be consumed through an electronic device. Examples of the digital experience include content creating, content editing, content tracking, content publishing, content posting, content printing, content managing, content viewing, content consuming, any combination of these experiences, or any other workflow or function that can be performed related to content.

Content, as described herein, includes electronic content. Examples of the content include, but are not limited to, image, video, website, webpage, user interface, menu item, tool menu, magazine, slideshow, animation, social post, comment, blog, data feed, audio, advertisement, vector graphic, bitmap, document, any combination of one or more content, or any other electronic content.

User devices 502A-502N can be connected to a creative apparatus 508 via a network 506. Examples of the network 506 include, but are not limited to, internet, local area network (LAN), wireless area network, wired area network, wide area network, and the like.

The creative apparatus 508 includes one or more engines for providing one or more digital experiences to the user. The creative apparatus 508 can be implemented using one or more servers, one or more platforms with corresponding application programming interfaces, cloud infrastructure and the like. In addition, each engine can also be implemented using one or more servers, one or more platforms with corresponding application programming interfaces, cloud infrastructure and the like. The creative apparatus 508 also includes a data storage unit 512. The data storage unit 512 can be implemented as one or more databases or one or more data servers. The data storage unit 512 includes data that is used by the engines of the creative apparatus 508.

A user of the user device 502A visits a webpage or an application store to explore applications supported by the creative apparatus 508. The creative apparatus 508 provides the applications as a software as a service (SaaS), or as a standalone application that can be installed on the user device 502A, or as a combination. The user can create an account with the creative apparatus 508 by providing user details and also by creating login details. Alternatively, the creative apparatus 508 can automatically create login details for the user in response to receipt of the user details. In some embodiments, the user is also prompted to install an application manager. The application manager enables the user to manage installation of various applications supported by the creative apparatus 508 and also to manage other functionalities, such as updates, subscription account and the like, associated with the applications. The user details are received by a user management engine 516 and stored as user data 518 in the data storage unit 512. In some embodiments, the user data 518 further includes account data 520 under which the user details are stored.

The user can either opt for a trial account or can make payment based on type of account or subscription chosen by the user. Alternatively, the payment can be based on product or number of products chosen by the user. Based on payment details of the user, a user operational profile 522 is generated by an entitlement engine 524. The user operational profile 522 is stored in the data storage unit 512 and indicates entitlement of the user to various products or services. The user operational profile 522 also indicates type of user, i.e. free, trial, student, discounted, or paid.

In some embodiment, the user management engine 516 and the entitlement engine 524 can be one single engine performing the functionalities of both the engines.

The user can then install various applications supported by the creative apparatus 508 via an application download management engine 526. Application installers or application programs 528 present in the data storage unit 512 are fetched by the application download management engine 526 and made available to the user directly or via the application manager. In one embodiment, an indication of all application programs 528 are fetched and provided to the user via an interface of the application manager. In another embodiment, an indication of application programs 528 for which the user is eligible based on user's operational profile are displayed to the user. The user then selects the application programs 528 or the applications that the user wants to download. The application programs 528 are then downloaded on the user device 502A by the application manager via the application download management engine 526. Corresponding data regarding the download is also updated in the user operational profile 522. An application program 528 is an example of the digital tool. The application download management engine 526 also manages the process of providing updates to the user device 502A.

Upon download, installation and launching of an application program, in one embodiment, the user is asked to provide the login details. A check is again made by the user management engine 516 and the entitlement engine 524 to ensure that the user is entitled to use the application program. In another embodiment, direct access is provided to the application program as the user is already logged into the application manager.

The user uses one or more application programs 504A-504N installed on the user device to create one or more projects or assets. In addition, the user also has a workspace within each application program. The workspace, as described herein, includes setting of the application program, setting of tools or setting of user interface provided by the application program, and any other setting or properties specific to the application program. Each user can have a workspace. The workspace, the projects, and/or the assets can be stored as application program data 530 in the data storage unit 512 by a synchronization engine 532. Alternatively or additionally, such data can be stored at the user device, such as user device 502A.

The application program data 530 includes one or more assets 540. The assets 540 can be a shared asset which the user wants to share with other users or which the user wants to offer on a marketplace. The assets 540 can also be shared across multiple application programs 528. Each asset includes metadata 542. Examples of the metadata 542 include, but are not limited to, font, color, size, shape, coordinate, a combination of any of these, and the like. In addition, in one embodiment, each asset also includes a file. Examples of the file include, but are not limited to, an image 544, text 546, a video 548, a font 550, a document 552, a combination of any of these, and the like. In another embodiment, an asset only includes the metadata 542.

The application program data 530 also include project data 554 and workspace data 556. In one embodiment, the project data 554 includes the assets 540. In another embodiment, the assets 540 are standalone assets. Similarly, the workspace data 556 can be part of the project data 554 in one embodiment while it may be standalone data in other embodiment.

A user can operate one or more user device to access data. In this regard, the application program data 530 is accessible by a user from any device, including a device which was not used to create the assets 540. This is achieved by the synchronization engine 532 that stores the application program data 530 in the data storage unit 512 and enables the application program data 530 to be available for access by the user or other users via any device. Before accessing the application program data 530 by the user from any other device or by any other user, the user or the other user may need to provide login details for authentication if not already logged in. In some cases, if the user or the other user are logged in, then a newly created asset or updates to the application program data 530 are provided in real time. The rights management engine 536 is also called to determine whether the newly created asset or the updates can be provided to the other user or not. The workspace data 556 enables the synchronization engine 532 to provide a same workspace configuration to the user on any other device or to the other user based on rights management data 538.

In various embodiments, various types of synchronization can be achieved. For example, the user can pick a font or a color from the user device 502A using a first application program and can use the font or the color in a second application program on any other device. If the user shares the font or the color with other users, then the other users can also use the font or the color. Such synchronization generally happens in real time. Similarly, synchronization of any type of the application program data 530 can be performed.

In some embodiments, user interaction with the applications 504 is tracked by an application analytics engine 558 and stored as application analytics data 560. The application analytics data 560 includes, for example, usage of a tool, usage of a feature, usage of a workflow, usage of the assets 540, and the like. The application analytics data 560 can include the usage data on a per user basis and can also include the usage data on a per tool basis or per feature basis or per workflow basis or any other basis. The application analytics engine 558 embeds a piece of code in the applications 504 that enables the application to collect the usage data and send it to the application analytics engine 558. The application analytics engine 558 stores the usage data as the application analytics data 560 and processes the application analytics data 560 to draw meaningful output. For example, the application analytics engine 558 can draw an output that the user uses “Tool 4” a maximum number of times. The output of the application analytics engine 558 is used by a personalization engine 562 to personalize a tool menu for the user to show “Tool 4” on top. Other types of personalization can also be performed based on the application analytics data 558. In addition, the personalization engine 562 can also use the workspace data 556 or the user data 518 including user preferences to personalize one or more application programs 528 for the user.

In some embodiments, the application analytics data 560 includes data indicating status of a project of the user. For example, if the user was preparing an article in a digital publishing application and what was left was publishing the prepared article at the time the user quit the digital publishing application, then the application analytics engine 558 tracks the state. Now when the user next opens the digital publishing application on another device, then the user is indicated and the state and options are provided to the user for publishing using the digital publishing application or any other application. In addition, while preparing the article, a recommendation can also be made by the synchronization engine 532 to incorporate some of other assets saved by the user and relevant for the article. Such a recommendation can be generated using one or more engines, as described herein.

The creative apparatus 508 also includes a community engine 564 which enables creation of various communities and collaboration among the communities. A community, as described herein, includes a group of users that share at least one common interest. The community can be closed, i.e., limited to a number of users or can be open, i.e., anyone can participate. The community enables the users to share each other's work and comment or like each other's work. The work includes the application program data 540. The community engine 564 stores any data corresponding to the community, such as work shared on the community and comments or likes received for the work as community data 566. The community data 566 also includes notification data and is used for notifying other users by the community engine in case of any activity related to the work or new work being shared. The community engine 564 works in conjunction with the synchronization engine 532 to provide collaborative workflows to the user. For example, the user can create an image and can request for some expert opinion or expert editing. An expert user can then either edit the image as per the user liking or can provide expert opinion. The editing and providing of the expert opinion by the expert is enabled using the community engine 564 and the synchronization engine 532. In collaborative workflows, a plurality of users is assigned different tasks related to the work.

The creative apparatus 508 also includes a marketplace engine 568 for providing marketplace to one or more users. The marketplace engine 568 enables the user to offer an asset for selling or using. The marketplace engine 568 has access to the assets 540 that the user wants to offer on the marketplace. The creative apparatus 508 also includes a search engine 570 to enable searching of the assets 540 in the marketplace. The search engine 570 is also a part of one or more application programs 528 to enable the user to perform search for the assets 540 or any other type of the application program data 530. The search engine 570 can perform a search for an asset using the metadata 542 or the file.

The creative apparatus 508 also includes a document engine 572 for providing various document related workflows, including electronic or digital signature workflows, to the user. The document engine 572 can store documents as the assets 540 in the data storage unit 512 or can maintain a separate document repository (not shown in FIG. 5).

In accordance with embodiments of the present invention, application programs 528 include a storyboarding application that facilitates automatic generation of storyboards from a textual scene description. In these embodiments, the storyboarding application is provided to the user device 502A (e.g., as application 504N) such that the storyboarding application operates via the user device. In another embodiment, a storyboarding tool (e.g., storyboarding tool 505A) is provided as an add-on or plug-in to an application such as a screenwriting application, as further described with reference to FIG. 1 above. These configurations are merely exemplary, and other variations for providing storyboarding software functionality are contemplated within the present disclosure.

It is to be appreciated that the engines and working of the engines are described as examples herein, and the engines can be used for performing any step in providing digital experience to the user.

### Exemplary Operating Environment

Having described an overview of embodiments of the present invention, an exemplary operating environment in which embodiments of the present invention may be implemented is described below in order to provide a general context for various aspects of the present invention. Referring now to FIG. 6 in particular, an exemplary operating environment for implementing embodiments of the present invention is shown and designated generally as computing device 600. Computing device 600 is but one example of a suitable computing environment and is not intended to suggest any limitation as to the scope of use or functionality of the invention. Neither should the computing device 600 be interpreted as having any dependency or requirement relating to any one or combination of components illustrated.

The invention may be described in the general context of computer code or machine-useable instructions, including computer-executable instructions such as program modules, being executed by a computer or other machine, such as a cellular telephone, personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 6, computing device 600 includes a bus 610 that directly or indirectly couples the following devices: memory 612, one or more processors 614, one or more presentation components 616, input/output (I/O) ports 618, input/output components 620, and an illustrative power supply 622. Bus 610 represents what may be one or more busses (such as an address bus, data bus, or combination thereof). Although the various blocks of FIG. 6 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventor recognizes that such is the nature of the art, and reiterates that the diagram of FIG. 6 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 6 and reference to “computing device.”

Computing device 600 typically includes a variety of computer-readable media. Computer-readable media can be any available media that can be accessed by computing device 600 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 600. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 612 includes computer-storage media in the form of volatile and/or nonvolatile memory. The memory may be removable, non-removable, or a combination thereof. Exemplary hardware devices include solid-state memory, hard drives, optical-disc drives, etc. Computing device 600 includes one or more processors that read data from various entities such as memory 612 or I/O components 620. Presentation component(s) 616 present data indications to a user or other device. Exemplary presentation components include a display device, speaker, printing component, vibrating component, etc.

I/O ports 618 allow computing device 600 to be logically coupled to other devices including I/O components 620, some of which may be built in. Illustrative components include a microphone, joystick, game pad, satellite dish, scanner, printer, wireless device, etc. The I/O components 620 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 600. The computing device 600 may be equipped with depth cameras, such as stereoscopic camera systems, infrared camera systems, RGB camera systems, touchscreen technology, and combinations of these, for gesture detection and recognition. Additionally, the computing device 600 may be equipped with accelerometers or gyroscopes that enable detection of motion. The output of the accelerometers or gyroscopes may be provided to the display of the computing device 600 to render immersive augmented reality or virtual reality.

Embodiments described herein support automatic generation of storyboards from a textual scene description. The components described herein refer to integrated components of an automatic storyboard generation system. The integrated components refer to the hardware architecture and software framework that support functionality using the automatic storyboard generation system. The hardware architecture refers to physical components and interrelationships thereof and the software framework refers to software providing functionality that can be implemented with hardware embodied on a device.

The end-to-end software-based automatic storyboard generation system can operate within the automatic storyboard generation system components to operate computer hardware to provide automatic storyboard generation system functionality. At a low level, hardware processors execute instructions selected from a machine language (also referred to as machine code or native) instruction set for a given processor. The processor recognizes the native instructions and performs corresponding low level functions relating, for example, to logic, control and memory operations. Low level software written in machine code can provide more complex functionality to higher levels of software. As used herein, computer-executable instructions includes any software, including low level software written in machine code, higher level software such as application software and any combination thereof. In this regard, the automatic storyboard generation system components can manage resources and provide services for the automatic storyboard generation system functionality. Any other variations and combinations thereof are contemplated with embodiments of the present invention.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer storage media storing computer-useable instructions that, when used by one or more computing devices, cause the one or more computing devices to perform operations comprising:
accessing a textual scene description;
identifying one or more storyboard elements from the textual scene description, the one or more storyboard elements comprising text indications of characters, actions or objects identified via grammatical components of the textual scene description;
obtaining one or more images corresponding to the one or more storyboard elements; and
providing the obtained one or more images for display as a storyboard.

2. The media of claim 1, the identification via grammatical components comprising:
identifying nouns in the textual scene description, identifying proper nouns and objects from the nouns, and identifying characters from the proper nouns;
identifying verbs in the textual scene description, and identifying actions from the verbs.

3. The media of claim 1, wherein the obtaining one or more images is from at least one of an image library or a custom image input.

4. The media of claim 3, further comprising
obtaining at least one image from a custom image library.

5. The media of claim 3, further comprising obtaining one or more images from an image library by searching textual descriptions of images in an index of the image library.

6. The media of claim 1 further comprising:
identifying at least one visual characteristic of a storyboard element;
creating a tag for each identified visual characteristic;
associating each tag with its corresponding storyboard element; and
obtaining at least one image based on a tag.

7. The media of claim 6 further comprising obtaining at least one image by searching textual descriptions of images in an index of an image library for a tagged visual characteristic.

8. A computerized method for facilitating the automatic generation of customizable storyboards, the method comprising:
accessing an input containing a textual scene description;
summarizing the textual scene description;
identifying one or more storyboard elements comprising characters, actions and objects from the summarized scene description by:
identifying nouns in the summarized scene description, identifying proper nouns and objects from the nouns, and identifying characters from the proper nouns; and
identifying verbs in the summarized scene description, and identifying actions from the verbs;
obtaining one or more images corresponding to the one or more storyboard elements; and
providing the obtained one or more images for display as a storyboard.

9. The method of claim 8, wherein each of the one or more images in the storyboard may be manipulated independently of any other of the one or more images.

10. The method of claim 8, wherein the obtaining one or more images is from at least one of an image library or a custom image input.

11. The method of claim 10, further comprising:
obtaining at least one image from a custom image library.

12. The method of claim 10, further comprising:
obtaining one or more images from an image library by searching textual descriptions of images in an index of the image library.

13. The method of claim 8, further comprising:
identifying at least one visual characteristic of a storyboard element;
creating a tag for each identified visual characteristic;
associating each tag with its corresponding storyboard element; and
obtaining at least one image based on a tag.

14. The method of claim 13 further comprising obtaining at least one image by searching textual descriptions of images in an index of an image library for a tagged visual characteristic.

15. A computer system comprising:
one or more hardware processors and memory configured to provide computer program instructions to the one or more hardware processors;
an input component configured to access an input containing a textual scene description;
a means for identifying one or more storyboard elements from the textual scene description via grammatical components of the textual scene description:
a visualization component configured to obtain one or more images corresponding to the one or more storyboard elements; and
a storyboard presentation component configured to provide the obtained one or more images for display as a storyboard.

16. The computer system of claim 15, additionally comprising an editor configured to receive desired image modifications and causing the modifications to be implemented.

17. The computer system of claim 15, wherein the visualization component is additionally configured to obtain images from at least one of an image library or a custom image input.

18. The computer system of claim 17, wherein the visualization component is additionally configured to obtain at least one image from a custom image library.

19. The computer system of claim 17, wherein the visualization component is additionally configured to obtain one or more images from an image library by searching textual descriptions of images in an index of the image library.

20. The computer system of claim 15, further comprising a tagging component configured to:
identify at least one visual characteristic of a storyboard element,
create a tag for each identified visual characteristic; and
associate each tag with its corresponding storyboard element;
and wherein the visualization component is additionally configured to obtain at least one image by searching textual descriptions of images in an index of an image library for a tagged visual characteristic.
